(19) United States
(12) Patent Application Publication
(10) Pub. No.: US 2014/0208597 A1
(43) Pub. Date: Jul. 31, 2014

(54) VEGETATION TRIMMER

(71) Applicant: Techtronic Outdoor Products Technology Limited, Hamilton (BM)

(72) Inventors: Haijun ZHOU, Dongguan (CN); Zhengjun WANG, Dongguan (CN); Hoi Pang WANG, Kowloon (HK); Koon For CHUNG, Sai Kung (HK)

(21) Appl. No.: 14/156,638

(22) Filed: Jan. 16, 2014

(30) Foreign Application Priority Data
Jan. 28, 2013 (CN) 201320046684.X

(51) Int. Cl. A01D 34/90

(52) U.S. Cl. CPC A01D 34/90
USPC 30/276

(57) ABSTRACT

A hand-held vegetation trimmer includes a shaft, a cutting blade disposed at a first end portion of the shaft, a first handle disposed at a second end portion of the shaft, and a motor in communication with the cutting blade. The motor is disposed on the shaft. The motor is concentric with the shaft and is located between the cutting blade and the first handle.

### TECHNICAL FIELD

The present invention relates to a vegetation trimmer, and in particular, a hand-held vegetation trimmer.

### BACKGROUND OF THE INVENTION

Hand-held vegetation trimmers are commonly used to cut and trim grass and other vegetation. They are particularly useful for trimming grass around trees, buildings, fences and other areas not easily accessible to a lawn mower.

A hand-held vegetation trimmer typically includes an elongated shaft having a cutting head at one end and a handle at the other end so that the user may hold the trimmer so that the cutting head is positioned near the grass. A motor is used to rotate the cutting head. Since the vegetation trimmer is hand-held, it is important that the user can effectively control the trimmer when the cutting head is rotating. Accordingly, the position of the handle and motor are important to maintain balance and control. Typically, the motor is located either at the bottom end of the shaft just above the cutting head or near the top end of the shaft behind the handle.

U.S. Pat. No. 7,627,952 provides a vegetation trimmer having a cutting head at one end of a flexible drive shaft and a front and rear handle located at the other end of the drive shaft. A motor for rotating the cutting head is located between the front and rear handle. The motor is offset from the drive shaft so that the motor is located beneath the drive shaft when the vegetation trimmer is oriented with the rear handle in an uppermost position.

### SUMMARY OF THE INVENTION

The present invention provides a hand-held vegetation trimmer including a shaft. A cutting blade is disposed at a first end portion of the shaft, and a first handle is disposed at a second end portion of the shaft. A motor is located on the shaft. The motor is located between the cutting blade and the first handle.

Preferably, the shaft is a flexible shaft. Still preferably, the flexible shaft includes a plurality of wires.

Preferably, the flexible shaft includes a first end portion and a second end portion, each end portion forming a square shaft.

Preferably, the hand-held vegetation trimmer further includes a sleeve surrounding the plurality of wires.

Preferably, the hand-held vegetation trimmer further includes a transmission portion connecting the motor with the shaft.

Preferably, the first handle includes a center portion attached to the shaft and two end portions, wherein each end portion extends generally perpendicular to the shaft.

Preferably, the hand-held vegetation trimmer further includes a second handle located at the second portion of the shaft so that the first handle is between the second handle and the cutting blade.

### BRIEF DESCRIPTION OF THE DRAWINGS

Features of the present invention will be better and is relevance to the following description of the invention which is given by way of example only.

FIG. 1 shows a perspective view of a preferred embodiment of a vegetation trimmer according to the present invention; and

FIG. 2 shows a partial view of the vegetation trimmer of FIG. 1.

### DETAILS DESCRIPTION OF THE PREFERRED EMBODIMENT

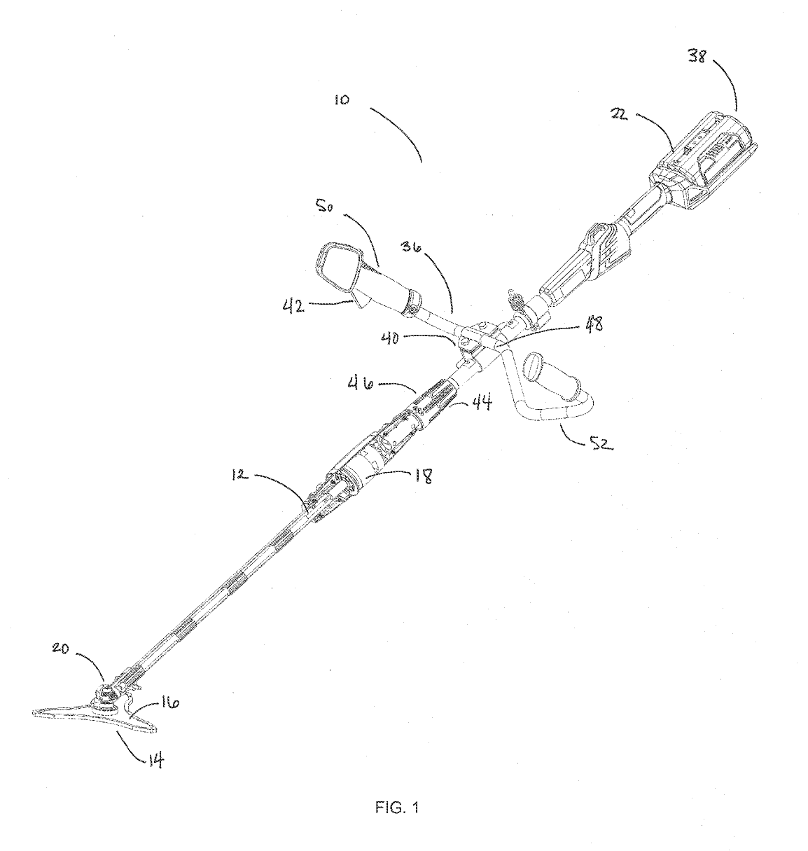

Referring to FIG. 1 the vegetation trimmer 10 includes a shaft 12 having a cutting blade 14 attached at one end and a front handle 36 attached at a second end. The shaft 12 may be formed from steel or other suitable material. A guard 16 is positioned around the cutting blade 14 to protect a user while the cutting blade 14 is rotating. The cutting blade 14 is driven by a motor 18 through the shaft 12 and a gear box 20. The motor 18 is attached concentrically with the shaft 12 and positioned about midway along the shaft 12 between the cutting blade 14 and the front handle 36. Positioning the motor 18 about midway along the shaft 12 improves balance thus making it easier to control the trimmer 10.

In one embodiment, the shaft 12 is a flexible shaft. The flexible shaft 12 further decreases shock to the motor 18 when the cutting blade 14 is rotating thus promoting easier control for the user as well as optimizing motor life. The flexible shaft 12 may be formed from a large bundle of entwined wires formed from steel, copper alloys, or other suitable material. Preferably, a sleeve, or casing 24 surrounds the flexible shaft 12. The casing 24 may be formed from a low friction, high strength, high temperature plastic such as nylon, Teflon or the like. Preferably, the casing 24 includes fiber reinforcement for wear resistance. The casing 24 includes one or more spacers 26 for centering the casing 24 within the housing 28. The spacers 26 may be formed from low friction, high strength plastics such as nylon, Teflon, or the like. Preferably, the spacers 26 are integral with the casing 24. Each end 30 of the flexible shaft 12 may be formed into a square shaft for torque transmission. Each end 30 may be welded together to avoid separation of the wire bundle. In this way no additional fittings are required.

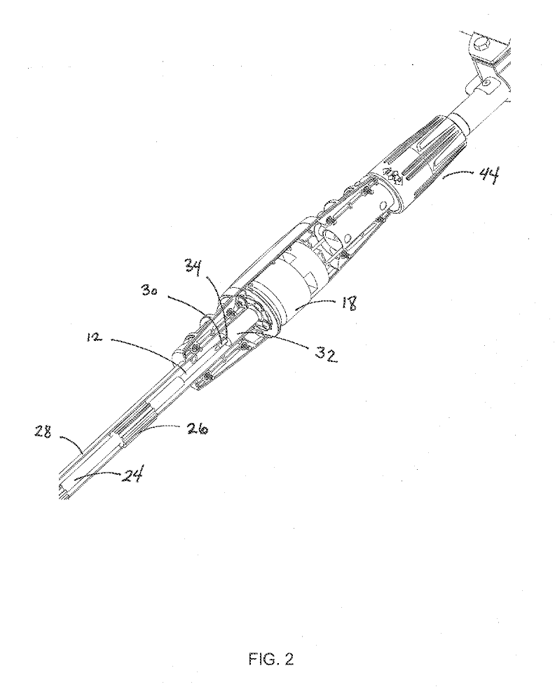

As shown in FIG. 2 an adaptor 32 connects the motor 18 and the shaft 12. The adaptor 32 includes a square aperture 34 to receive the square end of the shaft 12. A battery 22, attached to the other end of the shaft 12, provides power to the motor 18.

A rear handle 38 is attached to the shaft 12 near the battery 22. A bracket assembly 40 connects the front handle 36 to the shaft 12. The bracket assembly 40 includes a bracket and screws. The bracket assembly 40 allows the user to adjust the front handle 36 by moving it along the flexible shaft 12 and also by tilting the handle 36 forward or rearward to suit the user's height. The front handle 36 includes a center portion 48 attached to the shaft 12 and two end portions 50, 52. Each end portion 50, 52 extends generally perpendicular to the shaft 12, and may be shaped similar to a bicycle handle. This bicycle handle shape allows the user to more easily balance and control the trimmer 10 while the cutting blade 14 is rotating. Of course other handle shapes may also be suitable such as a J-shape, loop shape or the like. A shoulder harness (not shown) may also assist the user for more ergonomic use of the trimmer 10. The front handle 36 may also include a control switch 42 for controlling the cutting blade 14.

The rear handle 38 is attached to the shaft 12 between the front handle 36 and the battery 22 so that in use, the user is able to hold the trimmer 10 by grasping a portion of the front handle 36 with one hand and the rear handle 38 with the other hand and angle the trimmer 10 downward to engage the cutting blade 14 with the vegetation. Alternatively, the user may grasp only the front handle 36 with both hands.

Both the rear handle 38 and the motor 18 are assembled with a quick disconnect mechanism 44, 46 so that the user can easily disassemble the trimmer 10 for storage when not in use. The quick disconnect mechanism 44, 46 includes a plastic collar and two separate steel tube of different diameters overlapped together (not shown). It will be understood that other quick disconnect mechanisms may also be used such as a metal latch, cotter pin and clip or the like.

Although the invention has been described with reference to specific examples, persons skilled in the art will appreciate that the invention can be embodied in many other forms.

1. A hand-held vegetation trimmer comprising:
a shaft;
a cutting blade disposed at a first end portion of the shaft;
a first handle disposed at a second end portion of the shaft; and
a motor in communication with the cutting blade, the motor disposed on the shaft, wherein the motor is concentric with the shaft and located between the cutting blade and the first handle.

2. The hand-held vegetation trimmer of claim 1, wherein the shaft is a flexible shaft.

3. The hand-held vegetation trimmer of claim 2, wherein the flexible shaft includes a plurality of wires.

4. The hand-held vegetation trimmer of claim 2, wherein the flexible shaft includes a first end portion and a second end portion, each end portion forming a square shaft.

5. The hand-held vegetation trimmer of claim 3, further comprising a sleeve surrounding the plurality of wires.

6. The hand-held vegetation trimmer of claim 1, further comprising a transmission connecting the motor with the shaft.

7. The hand-held vegetation trimmer of claim 1, wherein the first handle includes a central portion attached to the shaft and two end portions, wherein each end portion extends generally perpendicular to the shaft.

8. The hand-held vegetation trimmer of claim 1, further comprising a second handle located at the second portion of the shaft so that the first handle is between the second handle and the cutting blade.

9. The hand-held vegetation trimmer of claim 8, wherein the second handle includes means to selectively control motor speed.

10. A hand-held vegetation trimmer comprising:
a housing;
a shaft positioned within the housing;
a cutting blade disposed at a first end portion of the shaft;
a handle supported by the housing and disposed adjacent a second end portion of the shaft;
a motor positioned within the housing and coupled to the shaft to drive the cutting blade through the shaft; and
a battery supported by the housing to provide power to the motor;
wherein the motor is located between the cutting blade and the handle, and wherein the handle is located between the motor and the battery pack.

11. The hand-held vegetation trimmer of claim 10, wherein the motor is located about midway between the cutting blade and the handle.

12. The hand-held vegetation trimmer of claim 10, wherein the motor is concentric with the shaft.

13. The hand-held vegetation trimmer of claim 10, wherein the shaft is a flexible shaft that includes a plurality of wires.

14. The hand-held vegetation trimmer of claim 13, wherein each end portion of the flexible shaft forms a square shaft.

15. The hand-held vegetation trimmer of claim 13, further comprising a sleeve surrounding the plurality of wires.

16. The hand-held vegetation trimmer of claim 15, wherein the sleeve includes a spacer for centering the flexible shaft within the housing.

17. The hand-held vegetation trimmer of claim 10, further comprising a transmission connecting the motor with the shaft.

18. The hand-held vegetation trimmer of claim 10, wherein the handle includes a central portion coupled to the housing and two end portions extending generally perpendicularly from the central portion.

19. The hand-held vegetation trimmer of claim 10, wherein the handle is a first handle, and further comprising a second handle spaced apart from the first handle and coupled to the housing.

20. The hand-held vegetation trimmer of claim 19, wherein the first handle is located between the motor and the second handle.
